(19) United States
(12) Patent Application Publication
(10) Pub. No.: US 2004/0093428 A1
(43) Pub. Date: May 13, 2004

(54) Network routing system

(75) Inventors: Jeremy Alan Arnold, Rochester, MN (US); Eric Lawrence Barsness, Pine Island, MN (US); Richard Dean Dettinger, Rochester, MN (US); John Matthew Santosuosso, Rochester, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY

(21) Appl. No.: 10/289,605

(22) Filed: Nov. 7, 2002

(51) Int. Cl. G06F 15/173

(52) U.S. Cl. 709/242

(57) ABSTRACT

A method, apparatus and program product verify routing accuracy for an electronic message intended for a recipient. The appropriateness of the electronic message being sent to an entered address is based on an evaluation of contextual information also associated with the electronic message. Upon a determination that the address is potentially inappropriate for the electronic message, corrective action may be initiated.

### FIELD OF THE INVENTION

The present invention relates generally to computer operations and applications, and more particularly, to the routing of electronic messages within a network environment.

### BACKGROUND OF THE INVENTION

The practice of electronically transmitting data over a computer network has become commonplace in government, commercial and personal endeavors. To this end, servers and associated software conventionally route electronic mail, digitized text, images and audio data between networked users. Exemplary networks supporting such data exchange may include intranets, ethemets and the Internet, as well as other forums that rely on transmission between interconnected devices. The popularity of electronic messaging is in part attributable to efficiency and expediency considerations associated with electronic mail, Internet chat rooms and other networked communication applications.

Electronic mail, for example, allows networked users to send digitized text, image and sound files to other networked users. In another application, chat rooms provide essentially real-time or instant messaging between users, where each user submits textual comments to an open window viewable by all users designated in a chat session. Similarly, instant messaging allows for real-time exchange of email-type communications between two networked users.

The very convenience and efficiency enjoyed by such applications, however, can often give rise to problems that detract from their own utility. Often, speed-driven features that promote quick responses can increase occurrences of erroneous transmission and routing. For instance, a user may be unaware that an automatically generated address associated with an outgoing electronic message does not match that of an intended recipient. In this manner, reliance on an automatic addressing mechanism can lead to misdirected communications.

Problems associated with conventional electronic addressing practices may be exacerbated in a multitasking environment, where the pace and number of ongoing electronic communications increase the potential for inappropriate routing. One such scenario may involve a user simultaneously participating in multiple chat room sessions that are concurrently being displayed in multiple windows. The plurality of simultaneous conversations may contribute to a failure on the part of the user to verify that the entered address for a particular message actually corresponds to that of an intended recipient. For instance, a social message sent to a friend may be inadvertently sent to a business associate.

In most cases, once a message is routed to a server there is no way to prevent its subsequent delivery to an unintended recipient(s). Such inadvertent transmission can translate into undesirable disclosure of confidential material, including compromise of developing projects. Other detrimental effects can include embarrassment and irritation to the user, as well as to the intended and actual recipients.

Consequently, and for in part the above delineated reasons, there exists a need for an improved manner of routing electronic transmissions.

### SUMMARY OF THE INVENTION

The present invention provides an improved apparatus, method and program product for routing an electronic transmission in a manner that addresses above-identified problems of conventional systems. In one respect, an embodiment of the present invention may determine whether an address associated with an electronic message is appropriate prior to delivery of the message to the recipient at that address. The determination of appropriateness may involve evaluation of contextual information further associated with the electronic message. Exemplary contextual information may relate to an address of a recipient and/or the user, or originator of the electronic message. Other contextual information may regard information independent of the address. In either case, contextual information may comprise a keyword or phrase, dialect, spelling/grammar, time of transmission and frequency of transmission, among other considerations. In determining appropriateness, the electronic message may be scanned or otherwise evaluated by program code in view of one or more of such factors.

Upon determining that the entered address is potentially inappropriate based upon the contextual information, the same or another embodiment may perform a corrective action prior to any transmission of the electronic message. Such corrective action may include temporarily buffering the electronic message in order to notify the sender of the potentially inappropriate address. Other suitable corrective actions may include prohibiting, deleting or rerouting the electronic message.

Among other benefits, the detection of potentially inappropriate addresses may diminish incidences of erroneous transmission. For instance, the user in the above multitasking chat room example may be provided with an improved mechanism that helps prevent mistaken addressing of electronic messages. Such a feature may increase the efficiency of the user by permitting the user to focus more on the content of the user's responses with a mitigated risk of inappropriate routing.

Where desired, evaluative criteria contained within the profile may augmented, deleted or otherwise modified to ensure current and tailored evaluations. Such versatility may further translate into more streamlined and efficient processing, in addition to more accurate routing. Moreover, mathematical weights or scaling may be assigned to certain criteria to reflect a relative importance inline with user preferences. Certain embodiments of the present invention may further enable automatic addressing of electronic messages according to the sampled contextual information.

By virtue of the foregoing there is less provided an improved electronic message routing mechanism that addresses shortcomings of conventional routing systems. These and other objects and advantages of the present invention shall be made apparent in the accompanying drawings and the description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a block diagram of a client-server computer system incorporating software consistent with the invention.

FIG. 2 is a block diagram of a networked communication system consistent with the invention and capable of implementing the client-server computer system of FIG. 1.

FIG. 3 is an electronic mail template consistent with the invention and having application within the systems of FIGS. 1 and 2.

FIG. 4 is a database schematic consistent with the invention and having application within the systems of FIGS. 1 and 2.

FIG. 5 is flowchart outlining method steps consistent with the invention and suited for execution within the systems of FIGS. 1 and 2.

FIG. 6 is flowchart outlining an exemplary user scenario consistent with the invention as executed within the systems of FIGS. 1 and 2.

### DETAILED DESCRIPTION

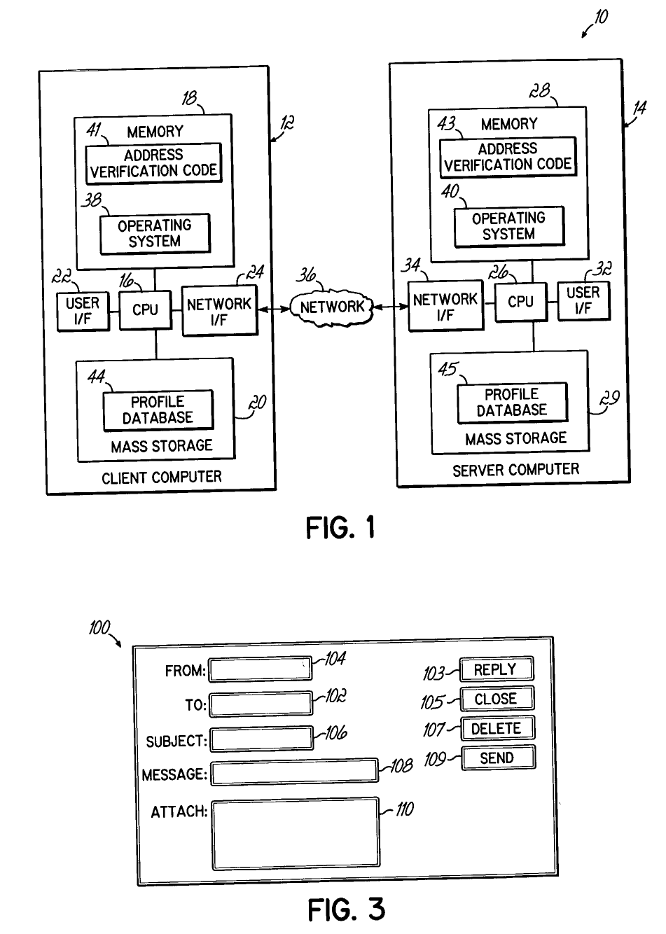

With reference generally to the embodiment of FIG. 1, there is shown a computer system 10 configured to verify the routing accuracy of an electronic message. In so doing, embodiments of the present invention may determine whether an address associated with the electronic message is appropriate. Such a determination of appropriateness may involve evaluation of contextual information associated with the electronic message. Exemplary contextual information may relate to a profile stored in association with the address of a recipient and/or the originator of the electronic message. As such, exemplary contextual information may include a keyword or phrase, dialect, spelling, grammar, a time of transmission and frequency of transmission, among other considerations.

Upon determining that the entered address is potentially inappropriate based on the contextual information, the same or another embodiment may perform a corrective action prior to any transmission of the electronic message. Such corrective action may include temporarily buffering the electronic message in order to notify the sender of the potentially inappropriate address. Other suitable corrective actions may include prohibiting, deleting and rerouting the electronic message. Verification and pause afforded by this feature may diminish incidents of erroneous transmission.

Turning now to the Drawings, wherein like numbers may denote like parts throughout the several views, FIG. 1 illustrates a client-server based computer system or environment 10 consistent with the invention. System 10 includes at least one apparatus, e.g., one or more client computers 12 and one or more server computers 14. For the purposes of the invention, each computer 12, 14 may represent practically any type of computer, computer system or other programmable electronic device capable of functioning as a client and/or server in a client-server environment. Moreover, each computer 12, 14 may be implemented using one or more networked computers, e.g., in a cluster or other distributed computing system. Moreover, as is common in many client-server systems, typically multiple client computers 12 will be interfaced with a given server computer 14. While more capable computer systems may present advantages in certain embodiments consistent with the principles of the present invention, a suitable server 14 for purposes of this specification may comprise any device configured to receive and process an electronic message transmitted from the client computer 12.

Client computer 12 typically includes a central processing unit 16 including at least one microprocessor coupled to a memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. For instance, the computer 12 may include a profile database 44 containing information correlated to either or both a recipient and originator of an electronic message. Such stored data may include contextual information useful in determining the appropriateness of an electronic message addressee.

In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12. As such, an embodiment consistent with the present invention may alternatively or additionally include a comparable profile database 45 on the server 14 side.

Computer 12 also typically receives a number of inputs and outputs for communicating information externally. For interface with a user or operator, computer 12 typically includes a user interface 22 incorporating one or more user input devices (e.g.; a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 12 may include an interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

In a similar manner to computer 12, computer 14 includes a CPU 26, memory 28, mass storage 29, user interface 32 and network interface 34. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU'S, memories, mass storage, user interfaces and network interfaces will typically vary between computers 12 and 14. For instance, memory 20, 29 of one system 10 consistent with the invention may include respective databases 44, 45 containing profile information as discussed above. However, on skilled in the art will appreciate that other hardware environments are contemplated within the context of the invention.

Computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each computer 12, 14 operates under the control of an operating system 38, 40 and executes or otherwise relies upon various computer software applications, components, programs, objects, modules, data structures, etc. Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. For instance, the embodiment of FIG. 1 includes address verification program code 42 configured to determine the appropriateness an address associated with an outgoing electronic message. Complementary program code 43 may reside on the server 14 side, though one of skill in the art should appreciate that embodiments consistent with the principles of the present invention may nonetheless use program code 42 resident at only one, or any number of locations.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

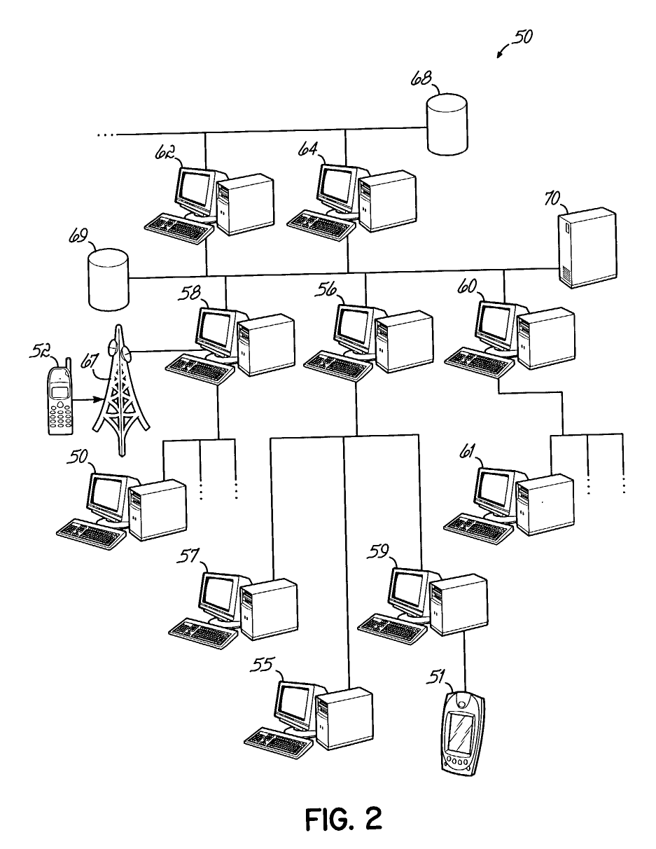

FIG. 2 shows networked system 50 capable of implementing the client-server computer system of FIG. 1 in a manner that is consistent with the principles of the present invention. As with the system 10 of FIG. 1, the system 50 of FIG. 2 is, in one respect, configured to determine the appropriateness of an address associated with an electronic message. The communications system 50 of FIG. 2 is generally configured to route the electronic message between networked users 51-64.

In the embodiment shown in FIG. 2, program code 42 executing at a user computer 57 and/or a server 56, 70 may determine whether an address assigned to an electronic message is appropriate for transmission. To this end, one system 50 consistent with the principles of the present invention may evaluate contextual information associated with the address of the electronic message to determine if the message is actually intended for its associated addressee(s). Another or the same exemplary application may determine whether the message is permitted or otherwise suited to be sent to the addressee(s).

The program code 42 of one embodiment may arrive at such a determination based upon an evaluation of contextual information surrounding the electronic message. For the purpose of one embodiment of the present invention, an electronic message may include any data sequence suitable for transmission, to include such data as is conventionally formatted according to email, chat room or machine language standards.

For explanatory purposes, FIG. 3 shows a typical email interface 100 as may be routinely utilized within the scope of the present invention. Program code 42 may sample the address field 102 of the interface 100 to determine the intended recipient(s). As discussed below, the program code 42 of another or the same embodiment may sample contextual information from other fields 103-110, as well as the circumstances surrounding intended transmission of the email. One of skill in the art should realize that although the conventional email application of FIG. 3 represents a template that may benefit from features of embodiments of the invention, processes consistent with the invention can be accomplished with regard to all known network transmission mediums. While not limited to such, exemplary contextual information relating to the email interface 100 and/or transmission may include factors such as: the size of the transmission, a keyword or phase, spelling, grammar, the presence of an attachment and/or a dialect used within the message. Other contextual information may regard the time at which message transmission is attempted, a detected data sequence, header data, as well as the frequency and pattern of transmissions initiated a user or group of users for the duration of a given period.

In determining the appropriateness of the electronic message for the intended recipient, the system 10 may initiate a comparison between the contextual information sampled by the system 10 and evaluative criteria, or profile data, retrieved from profile database 44 (FIG. 1). Suitable evaluative criteria may be retrieved from a profile stored within a database. For purposes of this disclosure, an evaluative criterion stored within a profile in accordance with the principles of the underlying invention may include any stored instruction or data useful in ascertaining the appropriateness of a given routing operation. A suitable database or other memory 69 storing one or more profiles may be maintained in a manner accessible to the program code 42 at either a server 56 or a local hard drive of the client 57, per system requirements. An exemplary profile may correlate to either or both the sender and an addressee.

Among other criteria, evaluative data populating a profile may include historical information sampled or otherwise derived from prior messages or other correspondence. The scope of the prior messages accounted for in such evaluative criteria may include transmissions originating from either or both of the sender and addressee. Evaluative criteria gleaned from historical correspondence particular to the addressee may be automatically sampled under certain conditions. For instance, the program code 42 may utilize commercial programs configured to sample unique words or phrases within the content or title of the electronic message. Such words may be stored within the database in a profile, the profile maintaining an associative relationship between the sender and the addressee. Similarly, the program code 42 may record in the profile the normal times of a day that the sender and addressee correspond. In similar fashion, the a profile may account for virtually any registerable characteristic, or contextual information, relating directly or indirectly to a string of transmitted electronic messages.

The profile may be populated over time in a manner that is transparent to the user. Another embodiment may include a disable function that allows the user to selectively apply the processes of the present invention. Moreover, the user or a system administrator may preset and modify what kind of contextual information is to be sampled. For instance, the user may wish to ignore contextual information relating to dialect, instead focusing only on those electronic messages that contain a more particularly relevant keyword, “confidential.” Such versatility may translate into more streamlined and efficient processing, in addition to more accurate routing.

Other profiles consistent with the invention may include evaluative criteria that is globally implemented by a system administrator for a grouping of users. For instance, it may be advantageous to screen all outgoing messages from a facility for sensitive data. As such, a criterion correlated to the sensitive data may be unilaterally established in profiles of all users having access to the data. For instance, evaluative criteria in a profile may be directed to all messages sent after six in the evening, or containing the name of a product still under development. In this manner, the program code 42 may use the criterion to scan outgoing messages for contextual information associated with the sensitive data. Typical profiles implemented in accordance with a system policy may contain criteria relating to: a keyword or combination of a keywords, header data, a binary sequence, a phrase, grammar, spelling, language, dialect, a stored glossary, an evolving glossary, system preferences, time of transmission, and user transmittal frequency, among other criteria.

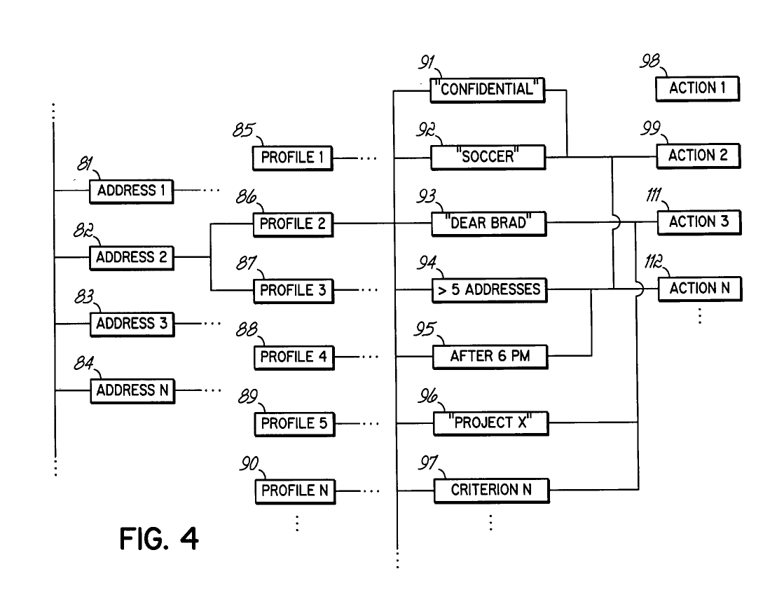

Such criteria may be stored in memory 18 comprising a database, such as is represented by the exemplary database schematic 80 of FIG. 4. As shown in the embodiment of FIG. 4, a suitable database may contain profiles 85-90 that link to fields 81-84 containing stored addresses. Where desired, exemplary addresses may include portions of addresses, such as may be common among the addresses of several different users supported by the same server. Such a feature may be advantageous where a common profile criterion applies universally to all users having the same address portion. The fields 81-84 may be searchable by the program code 42 so as to be correlated to an address field 102 of an electronic transmission. As such, a determined field 82 correlated to a determined address may link to one or more profiles 86, 88. For instance, a linked profile 86 may relate to a profile field 86 reflective of prior correspondence between the user and the addressee. Another linked profile 88 may regard a system wide policy, or generic profile 88.

Each profile 86, 88 may, in turn, link to one or more evaluative criteria fields 91-97. The linked evaluative criteria fields may contain criteria that the program code 42 uses as a basis to evaluate contextual information that regards the electronic message. For instance, one such criterion contained in a field 94 may cause the program code 42 to evaluate the electronic message for the presence of the phrase, “Dear Brad.” Each field 91-97 that contains an evaluative criterion may link to a field 98, 99, 111 or 112 containing instructions configured to bring about an appropriate action. In this manner, detection of the criterion may prompt a corrective or some other action pre-configured according to the database schematic 80.

Actions initiated by the program code 42 in response to detected contextual information (established via the profiles 85-90 of FIG. 4) may vary according to system configuration, function and specifications. As such, some profile data of an application may include preset criteria having an exclusionary purpose. Such exclusionary language may involve a glossary or other collection of text and/or attachments designated as being inappropriate for a given recipient or group of recipients. A network administrator or the user may set such a predetermination in accordance with company policy or a personal preference.

As such, a given profile may contain keywords or other evaluative criteria configured to restrict transmission of electronic messages having those keywords to only those addressees sharing a common designation. Such profiles may have application where specific teams of workers collaborate on a common project, the nature of which is not to be shared with others outside of the team. Another profile application may apply where a targeted consumer base receives electronic notifications that regard new product lines. As such, a profile may act to filter out erroneous data, to include outdated or unavailable inventory.

Other criteria of a given profile may link to actions that enable transmission. Such a configuration may act to verify that an electronic message is, in fact, addressed correctly. For instance, it may be desired that every message sent to a particular client contain disclaimers appended to the end of the message. As such, a profile may contain criteria suitable for the program code 42 to search against in order to determine if the desired language is present. If the language is detected, then the message may be ready for routing. Where such language has been omitted, the program code 42 of one embodiment may initiate a warning to apprize the sender of its absence.

The system 50 may initiate an evaluation process in response to user input and/or in accordance with administrator preferences. That is, program code 42 of one embodiment may compare the contextual information sampled from the electronic message to the evaluative criteria in response to direct user solicitation. Such user activation may include a sender selecting the program code 42 via a scroll-down window or a combination of typed keyboard characters. Topically, however, the system 10 may conduct or otherwise initiate evaluation processes in a manner that is transparent to the sender. For instance, program code 42 may initiate evaluation processes in response to a user clicking on or otherwise designating the send function 109 of FIG. 3. The send function 109 may be conventionally configured to initiate transmission of the electronic message.

Another application may initiate evaluation processes in response to other specific, preset occurrences, such as in response to detecting an entry of a particular address, keyword or other identifier. For instance, the system 50 may initiate an evaluation process by first identifying a particular address entered for the electronic message. Address data may conventionally be generated by a sender's action of typing in or clicking on a displayed address, as well as automatic reply features inherent to instant messaging systems. For example, program code 42 may scan the address entered in the appropriate field 102 of an electronic message 100 of FIG. 3 and attempt to correlate the address to a field 83 of the database 80 of FIG. 4. The entered address may correspond to a database field 83 that may link to a single or grouping of users.

More specifically, entry of the designated address into the appropriate field 102 of the email interface 100 of FIG. 3 may cause the system 50 to recall a profile correlated to the address and/or user. As discussed above, profile data recalled from the database and associated with the addressee may comprise historical message trends and data sample over a period of prior correspondence. Such profile data may include a glossary of words repeatedly used over the series of correspondence. For instance, a keyword designating an ongoing project frequently discussed by the sender and addressee may comprise an exemplary profile data point, or evaluative criterion. Of note, such profile data may be manually entered by a sender and/or be established automatically by the program code 42. Program code 42 of one embodiment may construct profiles as electronic messages are being written or transmitted. As with the above described contextual information, suitable evaluative data may regard any circumstance, attribute or characteristic relating to a message that is either quantifiable and/or registerable within a networked environment.

Another profile in accordance with the present invention may be generic to the sender or network. Such a profile may apply irrespective of the particular addresses of the recipients. For instance, a evaluative criteria may concern the user simultaneously sending an electronic message to more that five addresses. Other such profile data may regard a mandatory profile addressing concerns over transmissions to addresses not included within a company listing. Another embodiment may be configured to automatically and/or periodically scan electronic messages for contextual information in order to conduct evaluations at preset, recurring intervals.

In any case, the system 10 may reference the evaluative criteria recalled from the profile in order to sample the electronic message for appropriate contextual information. The sampling process may be uniform and repeatable as between different users of a network and/or different messages from the same user. A typical sampling program configured to search for evaluative criteria that comprises a keyword may include commercially available software that ignores common occurring words in favor of proper nouns and non-monosyllabic text.

The system may use the sampled contextual information to determine whether the entered address is appropriate for the electronic message. This appropriateness determination may include a comparison between the contextual information sampled from the electronic message and criteria recalled from the profile. Suitable comparisons may involve actual text, images and/or audio from the electronic message, as well as mathematical or other values representative of an aspect of the electronic message. For instance, determining appropriateness may include matching a keyword present in both the electronic message and a profile. Another exemplary matching criteria may relate to a phrase sampled from a subject line of the transmission, or a checksum value stored in associative relationship with the addressee.

As discussed herein, matches may be configured such that correlation within a preset tolerance may be indicative of either appropriateness or inappropriateness. Moreover, the same keyword may serve dual functions in the context of two different applications. For example, a user may cause a keyword corresponding to their child's name to act as criteria that verifies a message containing the child's name is appropriate for the address of a designated family member. Conversely, the same name of the child may be associated with a blacklist, or exclusionary glossary of keywords associated with the address of a business associate that acts to alert the system 10 when a word from the glossary is included in a transmission designating the business addressee. Such a configuration might help prevent a user from inadvertently sending an electronic message intended for a family member to the business associate.

Where the subject matter of the evaluated electronic transmission is determined to be appropriate to the addressee, the message may be automatically routed to the addressee without further delay. As such, the evaluation processes of system 50 may be imperceptible to the user. Another embodiment may nonetheless cause a dialog box that verifies the appropriateness of the addressee to be received by the sender.

Where program code 42 determines that an electronic message may be inappropriate as addressed, the system 10 may initiate corrective action. Typical corrective action may include a dialog box or other pop-up feature appearing on the monitor of a user prompting verification. As such, a suitable dialog box or other notification mechanism may query the sender, “are you sure you want to send the message to addressee?” Other suitable corrective action may in some instances include the program code's automatically readdressing the electronic message according to a programmatically determined, appropriate address. In another embodiment, a system administrator may configure the system 50 to delete messages having a particular inappropriate address.

While not required by the underlying principles of the present invention, the system 50 may buffer the electronic message in response to initialization of evaluation processes. Storage of the electronic message may accommodate the ways necessary for later corrective action. For instance, an electronic message having an incorrect address may be recalled instantly for the sender to reenter the correct addresses.

Program code 42 of still another embodiment may automatically determine an appropriate address for a message without requiring the sender to first enter the address of an intended recipient. For instance, the program code 42 may sample the contextual information and determine matches within a profile. The matches may correspond to a address stored in linked relationship within the database. The program code 42 may automatically promote this linked address to the address field 102 of an electronic message. Such a feature may potentially save time by promoting efficiency and mitigating instances of erroneous transmission. Where desired, the automatic addressing feature could be optionally disabled by a user.

While the above described corrective actions typically have application in most contexts, it should be understood by one in the art that corrective actions consistent with the principles with the present invention are not limited to those discussed above. Moreover, corrective actions suited for embodiments of the invention are virtually as limitless as the number of actions required for a particular system or project. Consequently and for purposes of this disclosure, a suitable corrective action may include any process initiated by program code 42 in response to a determination of the appropriateness of a message.

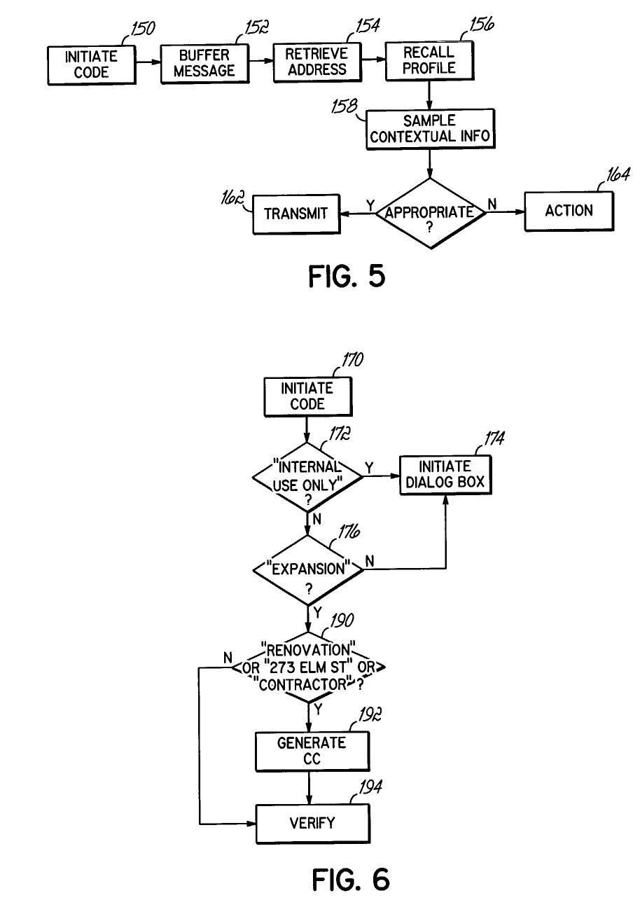

The flowchart of FIG. 5 illustrates exemplary sequence steps suitable for execution within the hardware environments of FIGS. 1 and 2. At block 150, a user may initiate routing verification processes. For instance, the user or an administrator may enable program code 42 configured to check the accuracy of routing prior to transmitting electronic messages originating from the sender by clicking on an icon or by initializing a machine. Once initiated, program code 42 of one embodiment may constantly monitor the generation and transmission of electronic messages originating from or forwarded from a user. As such, program code 42 may continuously monitor messages as text and/or attachments are added. Another embodiment may automatically initiate program code 42 just prior to transmission of an electronic message. For instance, program code 42 may evaluate an electronic message in response to the user selecting a send button 109 or other function.

One embodiment at block 152 may temporarily store, or buffer, the electronic message. This feature may preserve the integrity of the message during evaluation processes, as well as assist in possible subsequent corrective action. For example, a suitable corrective action may reproduce an electronic message found to have an inappropriate address to the user so that the user may merely readdress the message appropriately without having to re-accomplish the input of text into the message. Such storage may be performed locally or remotely at a location accessible to a server. Thus, the processes of block 152 may act to hold the original electronic message in stasis while an appropriateness determination is conducted subsequently at blocks 54-64. While buffering an electronic message at block 52 of the flowchart of FIG. 5 has particular advantages, it should be appreciated by one skilled in the art that buffering processes paralleling those of block 52 could be accomplished at any point or at multiple points, or be omitted altogether, while still remaining within the confines of the underlying principles of the present invention.

Routing verification processes may include accessing an address associated with the electronic message at block 154. While means of entry will vary as between different networks and user preferences, the address is typically entered by the user typing or otherwise selecting an address. Software of some electronic mailing systems may automatically finish an address begun by a user by extrapolating characters entered by the user against a notebook or other cache of stored addresses. Such practice introduces potential for error in that the sender may not assume the address finished by the software is in fact correct for the intended recipient. Program code 42 may scan the address field of a chat room message or email to determine if a profile or other set of stored instructions exists for the sampled address. As discussed herein, associating the address with such profile criteria may facilitate routing verification.

If such a profile corresponding to the entered address can be determined, then the information associated with the profile may be recalled at block 156. In one embodiment, profiles may be stored in a database 80 accessible to the program code 42. Fields 85-90 of the database 80 may link respective profile(s) to one or more address fields 81-84. Thus, a single address may link to multiple profiles, and the same profile may apply to a plurality of addresses. An exemplary profile may contain criteria relating to contextual information that may be sampled from the electronic message at block 158.

While not limited to such, exemplary contextual information sampled at block 158 may regard a keyword, phrase, grammar, spelling, language/dialect and/or an entire glossary of attributes. Other criteria may reflect a historical accounting of routing processes particular to the sender and the entered addressee. For purposes of this disclosure, contextual information may include data relating to the time messages are sent, as well as information concerning whether more than one e-mail was sent out within a specified duration of time. Still other criteria of the profile may reflect how many electronic message conversations the user was involved in at the time of the transmission. Motivation for such a profile could include a statistical probability that the sender would be more inclined to address an electronic message erroneously while involved in multiple conversations.

Of note, where no address matches a stored profile at block 156, one embodiment may recall a generic profile in addition to any applicable system and/or user profiles. Such a global profile could include criteria that prompts the program code 42 to search for the words, “confidential” or “proprietary.”

An embodiment of the present invention may use criteria gleaned from an applicable profile(s) at block 156 to sample the electronic message at block 158 for contextual information. For instance, program code 42 may initiate a search of text associated with the electronic message for a keyword, “Eiffel Tower,” as per a profile containing a glossary of French landmarks. In another or the same embodiment, software may sample proper nouns conveyed in the electronic message and run an evaluation/matching process against one or more profiles. As discussed herein, contextual information should be broadly construed to include data and circumstances relating to the generation, transmission and processing of the electronic message, in addition to the actual content of the same.

Software appropriate to conduct a comparison of the profile criteria and the contextual information sampled from the electronic message may vary as per different applications. For instance, program code 42 of one embodiment may affect a binary-based evaluation process in response to matching of a specific keyword. Other applications may require program code 42 to process statistical data, probabilities and averages in the course of an evaluation. For instance, where profile criteria conflict for a given message, that is, where some indicators are positive and others are negative, the program code 42 may be configured to interpolate or assign a level of confidence, such as a percentage, to the electronic message. To this end, mathematical weights may be assigned to different criteria. Exemplary confidence levels could be evaluated by the sender prior to transmission.

Depending on the network configuration, a match at block 160 may be determinative as to whether the message is appropriate or inappropriate as addressed. That is, profile criteria used to evaluate the contextual information may be either enabling or exclusive, in that instructions associated with the profile or network policy may cause the electronic message having certain contextual information to be delayed, transmitted directly, and/or brought to the attention of the sender. Evaluation of the electronic message(s) is typically conducted transparently to the user. Thus, any delay required by evaluation/verification processes does not significantly contribute to inefficiency and is typically imperceptible.

Where the evaluation at block 160 indicates that an electronic message is appropriately addressed, the message may be transmitted directly at block 162. As with all other steps of the flowchart of FIG. 3, such transmission may be accomplished transparently to the sender. However, where an electronic message and address combination is deemed inappropriate at block 160, corrective action may be initiated at block 164. Corrective action, which may include the above discussed confidence level notification, may further comprise deletion, prohibition rerouting, buffering and other notifications suited for a particular application. Such provision may translate into reduced incidents of erroneous transmission to unintended recipients. Aspects of the invention thus may provide an additional level of safeguarding configured to protect the integrity of a user and/or system's and user's communication integrity. In either case, the action taken by the program code 42 with regard to detected evaluative criterion may be determined by database linkage as discussed in the text describing FIG. 4.

It should be appreciated by one of skill in the art that the evaluative processes of block 160 may potentially involve multiple steps and evaluative criteria. Some such exemplary steps are illustrated in the flowchart of FIG. 6. More specifically, a user may initiate program code 42 consistent with the invention at block 170. Such initialization processes may include the user addressing an electronic message to a client, or preparing to transmit it with a send button 109.

Evaluative criteria recalled from a profile associated with the user and/or addressee may cause the program code 42 to scan the electronic message for the phrase, “Internal Use Only” at block 172. As the intended recipient of the electronic message is a client outside of the organization proper, detection of such a phrase may cause a corrective action at block 174. Such an action may comprise a dialog box appearing on the screen of the user. The dialog box may query the user as to their intention to send the message as addressed.

Similarly, the program code 42 may sample the electronic message at block 176 for a particular keyword. The keyword may relate to a subject that is considered sensitive to the operations of the sender's company, for instance. Where the keyword is detected at block 176, then the program code 42 may verify that the message is, in fact, intended for the addressee at block 174. Another or the same profile may cause the program code 42 to further evaluate the contextual information of the electronic message at block 190. Namely, the program code 42 may scan the message for any of three keyword phrases. Each phrase may link to a field 192 containing instructions configured to initiate transmission of a simultaneous, courtesy copy to third party, such as the sender's immediate supervisor. In this manner, embodiments of the present invention may recognize and react to a need to address an electronic message based on contextual information. Where desired, the program code 42 may verify at block 194 that the sender wishes the electronic message having the automatically generated address to be sent.

While the present invention has been illustrated by a description of various embodiments and while these embodiments have been described in considerable detail, it is not the intention of the applicants to restrict or in any way limit the scope of the appended claims to such detail. For instance, while the exemplary sequence of steps shown in FIGS. 5 and 6 may have particular utility in a certain context, it should be understood that the order of such steps may be rearranged and/or modified to suit different system requirements. Additional advantages and modifications will readily appear to those skilled in the art. Similarly, the embodiments of the present invention can enhance operation of conventional. Thus, the invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method for verifying routing accuracy of an electronic message, comprising:
determining whether an address associated with an electronic message is appropriate by evaluating additional contextual information associated with the electronic message; and
upon determining that the address is potentially inappropriate, performing a corrective action prior to any transmission of the electronic message to the address.

2. The method of claim 2, wherein determining whether the address associated with the electronic message is appropriate further includes transmitting the electronic message in response to determining that the address is appropriate.

3. The method of claim 1, wherein performing a corrective action further includes selecting the corrective action from a group consisting of: buffering the electronic message, deleting the electronic message, rerouting the electronic message, reproducing the electronic message, prohibiting transmission of the electronic message, assigning a confidence level to the electronic message and some combination thereof.

4. The method of claim 1, wherein performing a corrective action further includes automatically addressing a second electronic message.

5. The method of claim 4, further comprising disabling program code used to automatically address a second electronic message.

6. The method of clam 1, wherein determining whether the address associated with the electronic message is appropriate further comprises evaluating contextual information selected from a group consisting of: a keyword, a phrase, grammar, spelling, language, dialect, stored glossary, current glossary, user history, user preferences, time of transmission, frequency of messages and some combination thereof.

7. The method of claim 1, wherein determining whether the address associated with the electronic message is appropriate comprises making the determination at a server.

8. The method of claim 1, wherein determining whether the address associated with the electronic message is appropriate comprises making the determination at a client station associated with an originator of the electronic message.

9. The method of claim 1, wherein determining that the address is potentially inappropriate further includes comparing the contextual information to a criterion recalled from a profile.

10. The method of claim 9, wherein determining that the address is potentially inappropriate further includes generating the profile.

11. The method of claim 9, wherein generating the profile further comprises selecting the criterion from a distribution pattern.

12. The method of claim 9, wherein generating the profile further comprises selecting the criterion from a user preference.

13. The method of claim 9, wherein generating the profile further comprises selecting the criterion from historical data.

14. The method of claim 9, wherein generating the profile further comprises selecting the criterion from a system policy.

15. The method of claim 9, wherein generating the profile further comprises selecting the criterion from a transmission convention.

16. The method of claim 9, wherein generating the profile further comprises selecting the criterion from a routing norm.

17. The method of claim 9, wherein generating the profile further comprises selecting the criterion from an average processing requirement.

18. The method of claim 9, wherein generating the profile further comprises selecting the criterion from a checksum value.

19. The method of claim 9, wherein generating the profile further comprises selecting the criterion from an attachment.

20. The method of claim 9, wherein generating the profile further comprises selecting the criterion from a file size.

21. The method of claim 9, further comprising updating the profile.

22. The method of claim 1, further comprising storing the profile.

23. The method of claim 1, wherein determining that the address is potentially inappropriate further includes evaluating the address in association with evaluating the contextual information.

24. The method of claim 1, further comprising assigning a mathematical weight to the criterion.

25. The method of claim 1, wherein evaluating contextual information associated with the electronic message further comprises evaluating contextual information associated with the address.

26. The method of claim 1, further comprising automatically addressing the electronic message.

27. The method of claim 1, further comprising disabling program code used in the determination of whether the address associated with the electronic message is appropriate.

28. An apparatus, comprising:
a memory;
a database resident in the memory, the database storing evaluative criteria associated with an address; and
a program configured to sample contextual information associated with an electronic message and to access the database in order to correlate the evaluative criteria to the contextual information, thereby determining if the address is appropriate for the electronic message, the program being further configured to initiate a corrective action prior to any transmission of the electronic message to the address.

29. The apparatus of claim 28, wherein the program code initiates transmittal of the electronic message in response to determining that the address is appropriate.

30. The apparatus of claim 28, wherein the corrective action is selected from a group consisting of: buffering the electronic message, deleting the electronic message, rerouting the electronic message, reproducing the electronic message, prohibiting transmission of the electronic message, assigning a confidence level to the electronic message and some combination thereof.

31. The apparatus of claim 28, wherein the corrective action further includes automatically addressing a second electronic message.

32. The apparatus of claim 28, wherein the contextual information is selected from a group consisting of: a keyword, a phrase, grammar, spelling, language, a dialect, a stored glossary, a current glossary, a user history, a user preference, a time of transmission, a frequency of messages and some combination thereof.

33. The apparatus of claim 28, wherein the program code executes at a server.

34. The apparatus of claim 28, wherein the program code executes at a client station associated with an originator of the electronic message.

35. The apparatus of claim 28, wherein the program code initiates a comparison of the contextual information to a criterion recalled from a profile.

36. The apparatus of claim 35, wherein the program code initiates generation of the profile.

37. The apparatus of claim 35, wherein the program code initiates selecting the criterion from a distribution pattern.

38. The apparatus of claim 35, wherein the program code initiates selecting the criterion from a transmission convention.

39. The apparatus of claim 35, wherein the program code initiates selecting the criterion from a system policy.

40. The apparatus of claim 35, wherein the program code initiates selecting the criterion from historical data.

41. The apparatus of claim 35, wherein the program code initiates selecting the criterion from a user preference.

42. The apparatus of claim 35, wherein the program code initiates storing the profile.

43. The apparatus of claim 35, wherein the program code initiates assigning a mathematical weight to the criterion.

44. The apparatus of claim 35, wherein the program code enables updating the profile.

45. The apparatus of claim 28, wherein the program code initiates automatically addressing the electronic message.

46. The apparatus of claim 28, wherein the program code determines if the address is appropriate by evaluating the address in association with evaluating the contextual information.

47. A program product, comprising:
program code configured to determine the appropriateness of an address associated with an electronic message, wherein the program code is configured to sample contextual information associated with the electronic message and compare the contextual information against evaluative criteria retrieved from a database, wherein the program code is further configured to initiate a corrective action in response to the comparison and prior to any transmission of the electronic message to the address; and
a signal bearing medium bearing the program code.

48. The program product of claim 47, wherein the signal bearing medium includes at least one of a recordable medium and a transmission-type medium.
